(19) United States
(12) Patent Application Publication
(10) Pub. No.: US 2026/0217321 A1
(43) Pub. Date: Jul. 30, 2026

(54) TRACTOR

(71) Applicants: INTRADIN (SHANGHAI) INTELLIGENT MACHINERY CO., LTD., Shanghai (CN); GREAT CIRCLE MACHINERY CORP, ONTARIO, CA (US)

(72) Inventors: Wei ZHOU, Shanghai (CN); Junliang WANG, Shanghai (CN)

(21) Appl. No.: 19/578,209

(22) Filed: Mar. 25, 2026

(30) Foreign Application Priority Data
Sep. 30, 2025 (CN) 202522129653.6

(51) Int. Cl. B62D 51/00; B60D 1/06; B62D 51/04; B62D 61/10

(52) U.S. Cl. CPC B62D 51/001; B60D 1/06; B62D 51/04; B62D 61/10

(57) ABSTRACT

A tractor includes a frame and a wheel assembly. The wheel assembly includes a crossbeam, a swing axle, a first wheel, a second wheel and a pin. The crossbeam is arranged on a first end of the frame. The crossbeam is provided with a first hole running through the crossbeam along a length direction of the crossbeam. The swing axle is inserted into the first hole. A cross-sectional dimension of the swing axle is smaller than that of the first hole. The pin is inserted in the swing axle and the crossbeam. The swing axle is configured to swing upward and downward within the first hole around an axis of the pin. The first wheel is rotatably arranged on the swing axle. The second wheel is rotatably arranged on a second end of the frame.

### CROSS-REFERENCE TO RELATED APPLICATIONS

This application claims the benefit of priority from Chinese Patent Application No. 202522129653.6, filed on September 30, 2025. The content of the aforementioned application, including any intervening amendments thereto, is incorporated herein by reference in its entirety.

### TECHNICAL FIELD

This application relates to transportation tools, and more particularly to a tractor.

### BACKGROUND

In industrial production and logistics transportation, it is often necessary to transport various types of goods from one location to another. These goods come in numerous types and generally require different forms of cargo carriers for transport and transfer. Owing to the cargo carriers themselves lack power, specialized tractors are needed for towing and transportation.

In existing tractors, four wheels are typically directly fixed on its frame. When a tractor travels over uneven ground, one of the four wheels may frequently lose contact with the ground or have insufficient contact, leading to a risk of rollover, which significantly impacts towing performance and poses safety hazards.

### SUMMARY

In view of the foregoing, it is necessary to provide a tractor, so as to solve the above problems.

A tractor is provided, comprising:

a frame; and

a first wheel assembly;

wherein the first wheel assembly comprises a crossbeam, a swing axle, a first wheel, a second wheel and a pin; the crossbeam is arranged on a first end of the frame; the crossbeam is provided with a first hole, and the first hole is configured to run through the crossbeam along a length direction of the crossbeam; the swing axle is inserted through the first hole; a cross-sectional dimension of the swing axle is smaller than that of the first hole; the pin is inserted in the swing axle and the crossbeam; the swing axle is configured to swing upward and downward within the first hole around an axis of the pin; and the first wheel is rotatably arranged on the swing axle; and the second wheel is rotatably arranged on a second end of the frame, and is configured to drive the tractor.

In an embodiment, the first wheel assembly further comprises a connecting component; an upper part of the connecting component is fixedly arranged on an end of the swing axle; a lower part of the connecting component is connected with the first wheel; and the first wheel is configured to rotate relative to the connecting component.

In an embodiment, the number of the connecting component is two, the number of the first wheel is two, and the number of the second wheel is two; two connecting components are arranged on two ends of the swing axle, respectively; two first wheels are connected with the two connecting components, respectively; and two second wheels are arranged on two sides of the frame, respectively.

In an embodiment, the first wheel assembly is provided with a second hole configured to run through the crossbeam and the swing axle; the pin comprises a pin head, a pin shaft and a fixing component; the pin head is provided on a first end of the pin shaft; the pin shaft is inserted into the second hole; the fixing component is arranged on a second end of the pin shaft; and the pin head and the fixing component are respectively arranged on two opposite outer side walls of the crossbeam.

In an embodiment, the tractor further comprises a ball joint; and the ball joint is arranged on the frame, and is configured to connect with a cargo carrier.

In an embodiment, the tractor further comprises a second wheel assembly; the second wheel assembly is arranged on the second end of the frame, and is arranged spaced apart from the second wheel.

In an embodiment, the second wheel assembly comprises a connecting rod and a third wheel; a first end of the connecting rod is connected with the frame, and a second end of the connecting rod is connected with the third wheel; and the third wheel is configured to rotate relative to the connecting rod.

In an embodiment, the tractor further comprises a driving component; the driving component is arranged on the frame, and is connected with the second wheel; and the driving component is configured to drive the second wheel to rotate relative to the frame, so as to drive the frame to move.

In an embodiment, the tractor further comprises a controller; the controller is arranged on the frame, and is electrically connected with the driving component; and the controller is configured to control the driving component to start or stop.

In an embodiment, the tractor further comprises a handle; the handle is connected with the crossbeam, and is configured for an operator to hold.

The present disclosure has the following beneficial effects.

The present disclosure provides the tractor. In the tractor, the pin is configured to connect the swing axle and the crossbeam, and the swing axle is inserted through the first hole, so that the two ends of the swing axle can swing up and down within the first hole around the axis of the pin. When the tractor moves over uneven ground, the first wheel assembly can ensure the first wheel to maintain continuous contact with the ground. When a first wheel on one side of the tractor is forced to lift, a first wheel on the other side of the tractor is pressed downward, achieving tighter contact with the ground, which enhances ground contact performance of the tractor and ensures wheel-to-ground contact. Therefore, the tractor of the disclosure improves ability to pass through rough roads and towing capacity.

### BRIEF DESCRIPTION OF THE DRAWINGS

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a structural diagram of a tractor according to an embodiment of the present disclosure.

FIG. 2 is a structural diagram of a first wheel assembly and a frame according to an embodiment of the present disclosure.

FIG. 3 is a structural diagram of a pin according to an embodiment of the present disclosure.

FIG. 4 is a structural diagram of a crossbeam according to an embodiment of the present disclosure.

In the figures: 1, frame; 2, first wheel assembly; 21, crossbeam; 22, swing axle; 23, first wheel; 24, pin; 241, pin shaft; 242, pin head; 243, fixing component; 25, first hole; 26, connecting component; 27, second hole; 3, second wheel; 4, ball joint; 5, second wheel assembly; 51, connecting rod; 52, third wheel; 6, driving component; 7, controller; 8, handle; and 9, remote control unit.

Realization of objections, function characteristics and advantages of the present disclosure will be further described with reference to the embodiments and accompanying drawings

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

It should be noted that the terms, such as “up”, “down”, “left”, “right”, “front”, “rear” and other directional indications used herein, are only used for illustrating relative position relationship and motion between components in a specific state (as shown in the accompanying drawings). If the specific state changes, the directional indication accordingly changes.

In addition, the terms “first” and “second” are only used for distinguishment rather than indicating or implying the relative importance or implicitly specifying the number of technical features indicated. Therefore, a feature defined with “first” or “second” may explicitly or implicitly indicates the inclusion of at least one of such features. Besides, the term “and/or” used herein includes three solutions, for example, “A” and/or “B” includes solution “A”, solution “B”, and a combination thereof. Technical solutions of embodiments can be combined with each other as long as the combined solution can be implemented by those skilled in the art. When a combination of the technical solutions is contradictory or cannot be realized, it should be considered that such a combination does not exist, and is not within the scope of the present disclosure.

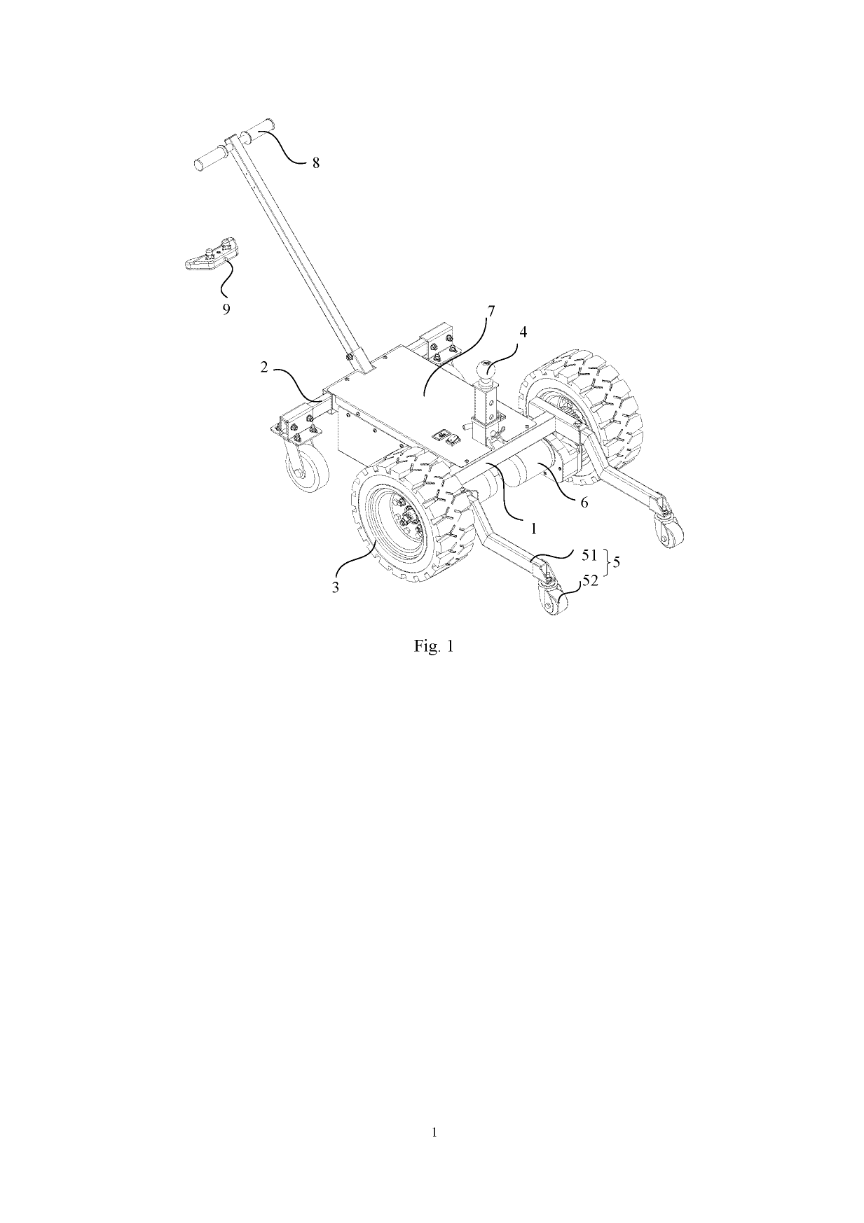

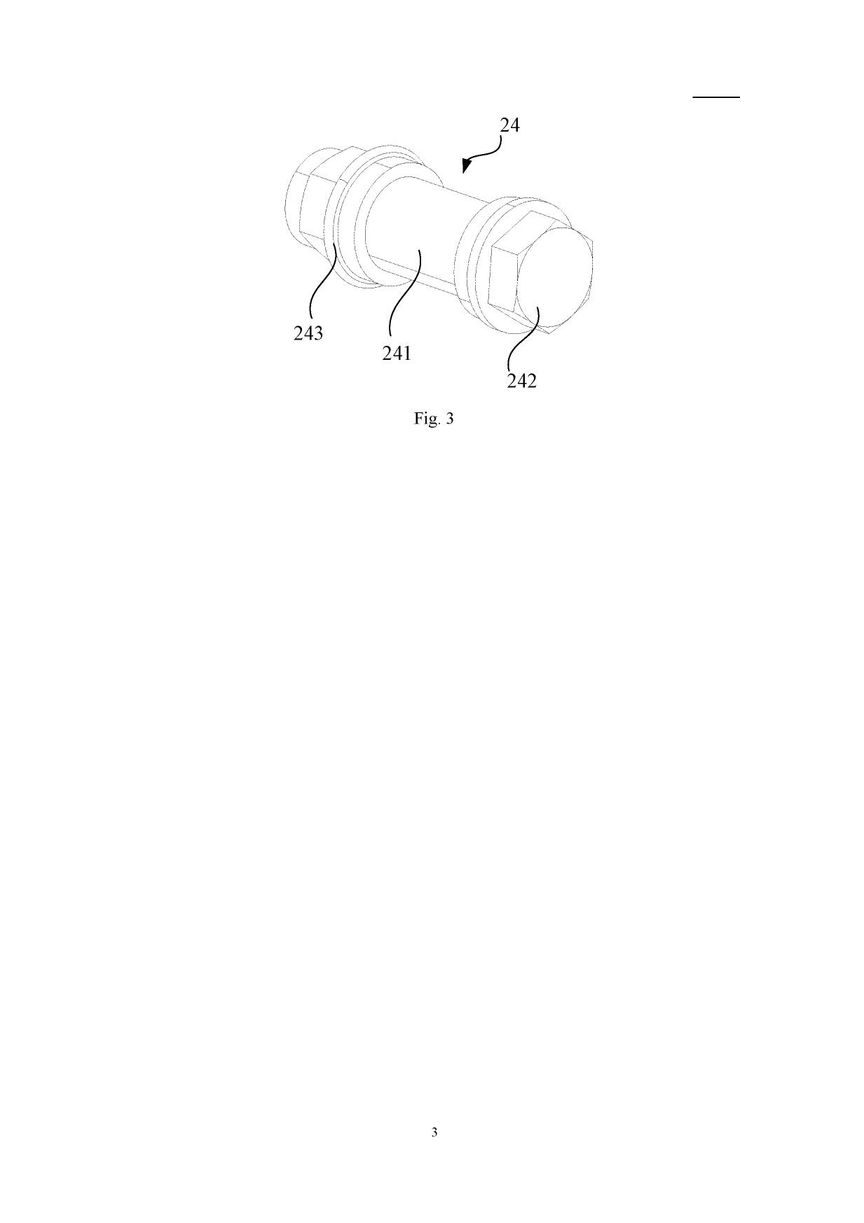

Referring to FIGS. 1-3, the present disclosure provides a tractor. The tractor includes a frame 1 and a first wheel assembly 2. The first wheel assembly 2 includes a crossbeam 21, a swing axle 22, a first wheel 23, a second wheel 3 and a pin 24. The crossbeam 21 is arranged on a first end of the frame 1. The crossbeam 21 is provided with a first hole 25, and the first hole 25 is configured to run through the crossbeam 21 along a length direction of the crossbeam 21. The swing axle 22 is inserted through the first hole 25. A cross-sectional dimension of the swing axle 22 is smaller than that of the first hole 25. The pin 24 is inserted in the swing axle 22 and the crossbeam 21. The swing axle 22 is configured to swing upward and downward within the first hole 25 around an axis of the pin 24. The first wheel 23 is rotatably arranged on the swing axle 22. The second wheel 3 is rotatably arranged on a second end of the frame 1, and is configured to be driven to rotate relative to the frame 1, so as to drive the frame 1 to move.

In the tractor of the present disclosure, the pin 24 connects the swing axle 22 and the crossbeam 21, and the swing axle 22 is inserted through the first hole 25, so that two ends of the swing axle 22 can swing up and down within the first hole 25 around the axis of the pin 24. When the tractor moves over uneven ground, the first wheel assembly 2 can ensure the first wheel 23 to maintain continuous contact with the ground. When a first wheel 23 on one side of the tractor is forced to lift, a first wheel 23 on the other side of the tractor is pressed downward, achieving tighter contact with the ground, which enhances ground contact performance of the tractor and ensures contact between the first wheel 23 and the ground. Therefore, the tractor of the disclosure improves ability to pass through rough roads and towing capacity.

Besides, in the tractor of the prior art, four wheels are directly fixed on the frame 1, and bottoms of the four wheels are required to remain on the same plane, which requires exceedingly high manufacturing and assembly demands. In contrast, the tractor of the present disclosure provides the swing axle 22, enabling the first wheel assembly 2 to autonomously adapt to terrain variations, which reduces manufacturing and assembly costs of the first wheel 23, allows for greater tolerance ranges, and lowers requirements for manufacturing and installation accuracy.

In an embodiment, the crossbeam 21 is fixedly connected with a front end of the frame 1. The crossbeam 21 and the swing axle 22 each have a square tube structure. An extension direction of the pin 24 is consistent with a traveling direction of the tractor.

In this embodiment, the swing axle 22 has the cross-sectional dimension of a height of 50 mm and a width of 30 mm. The first hole 25 has the cross-sectional dimension of an inner diameter height of 74 mm and an inner diameter width of 34 mm.

The swing axle 22 has a rotation angle of approximately ±5° relative to the crossbeam 21, preventing excessive angles that could cause a chassis to contact the ground and destabilize a center of gravity of the tractor.

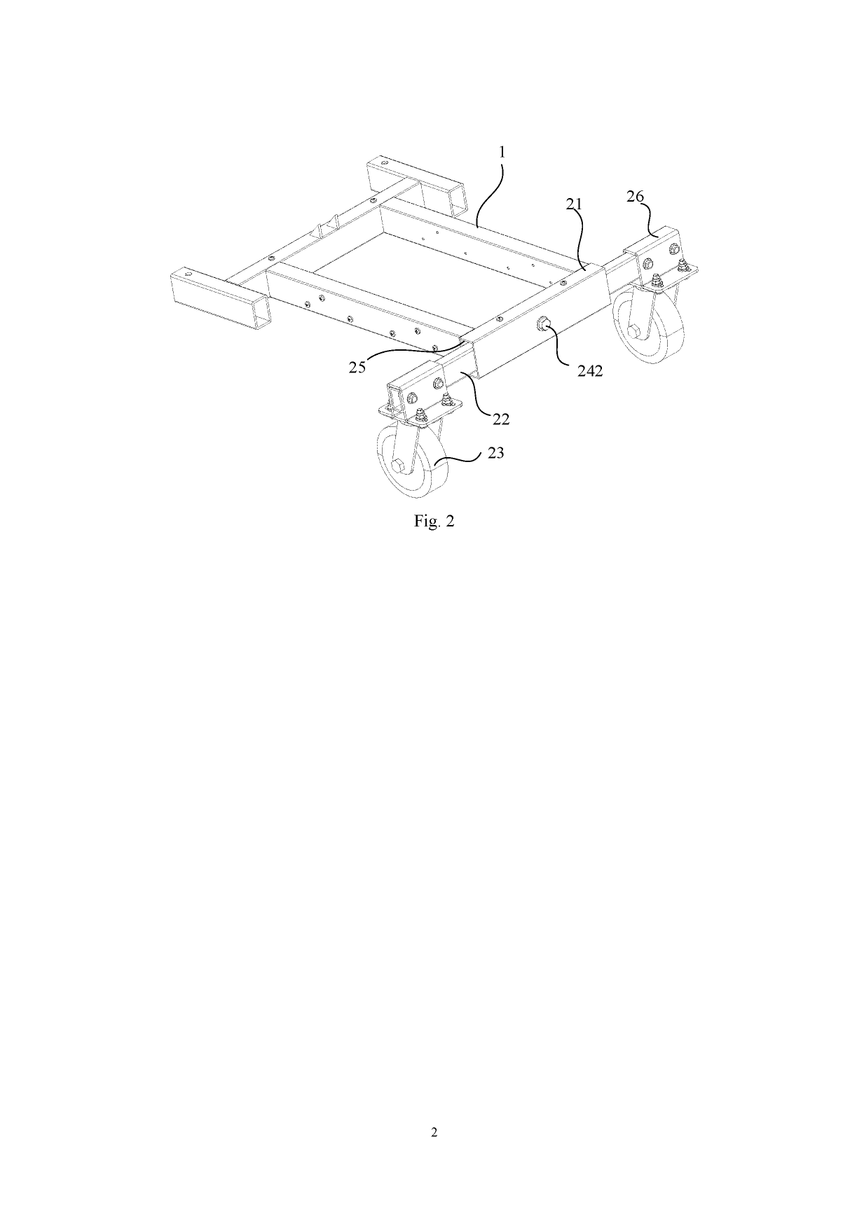

Referring to FIGS. 1-2, the first wheel assembly 2 includes a connecting component 26. An upper part of the connecting component 26 is fixedly arranged on an end of the swing axle 22. A lower part of the connecting component 26 is connected with the first wheel 23. The first wheel 23 is configured to rotate relative to the connecting component 26.

In this embodiment, the number of the connecting component 26 is two, the number of the first wheel 23 is two, and the number of the second wheel 3 is two. Two connecting components 26 are arranged on two ends of the swing axle 22, respectively. Two first wheels 23 are connected with the two connecting components 26, respectively; and arranged on two sides of the front end of the frame 1, respectively. Two second wheels 3 are arranged on two sides of a rear end of the frame 1, respectively.

Referring to FIGS. 1-4, the first wheel assembly 2 is provided with a second hole 27 configured to run through the crossbeam 21 and the swing axle 22. The second hole 27 is communicated with the first hole 25. An axis direction of the second hole 27 is perpendicular to that of the first hole 25. The pin 24 includes a pin head 242, a pin shaft 241, and a fixing component 243. The pin head 242 is provided on a first end of the pin shaft 241. The pin shaft 241 is inserted into the second hole 27. The fixing component 243 is arranged on a second end of the pin shaft 241. The pin head 242 and the fixing component 243 are respectively arranged on two opposite outer side walls of the crossbeam 21.

In an embodiment, the second hole 27 includes a third hole and a second hole. The third hole is inserted through the crossbeam 21. The second hole is inserted through the swing axle 22. The third hole and the fourth hole have identical dimensions. An axis of the third hole is arranged coaxially with that of the fourth hole. The pin shaft 241 is inserted into the third hole and the fourth hole.

In an embodiment, the second hole 27 is arranged on a central part of the crossbeam 21 and the swing axle 22. The pin head 242 and the pin shaft 241 are integrally formed. The fixing component 243 is sleevedly provided on the pin shaft 241. The fixing component 243 is connected with the pin shaft 241 through threaded fastening. The second hole 27 cooperates with the pin 24, so as to connect the crossbeam 21 with the swing axle 22. The fixing component 243 cooperates with the pin head 242, so that the pin shaft 241 is fixed in the second hole 27, preventing the pin shaft 241 from falling out.

Referring to FIG. 1, the tractor further includes a ball joint 4. The ball joint 4 is arranged on the frame 1, and is configured to connect with a cargo carrier which is for carrying goods. In an embodiment, the cargo carrier is provided with a ball joint sleeve, and the ball joint sleeve is configured to clamp with the ball joint 4, so as to connect the cargo carrier and the tractor, further allowing the cargo carrier to move synchronously with the tractor, and enabling the transfer of the goods.

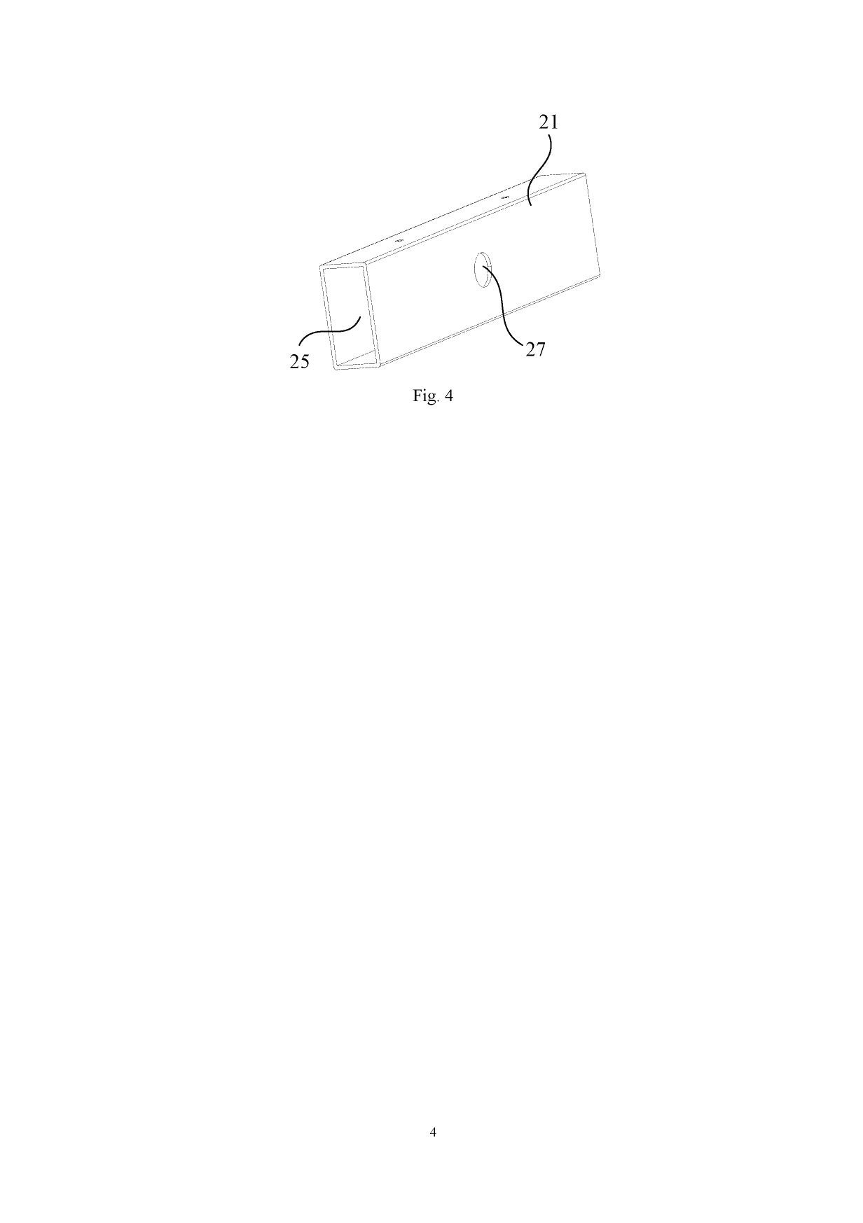

Referring to FIGS. 2 and 4, the tractor further includes a second wheel assembly 5. The second wheel assembly 5 is removably arranged on the second end of the frame 1 and spaced apart from the second wheel 3.

In this embodiment, the number of the second wheel assembly 5 is two. Two second wheel assemblies 5 are arranged on the two sides of the rear end of the frame, respectively. The two second wheel assemblies 5 are also arranged on inner sides of the two second wheels 3, respectively.

Referring to FIG. 1, the second wheel assembly 5 includes a connecting rod 51 and a third wheel 52. A first end of the connecting rod 51 is connected with the frame 1, and a second end of the connecting rod 51 is connected with the third wheel 52. The third wheel 52 is configured to rotate relative to the connecting rod 51.

In this embodiment, the number of the connecting rod 51 and the third wheel 52 is each two. The connecting rod 51 has an approximately Z-shaped structure. Two connecting rods 51 are connected with the frame 1, respectively. The two connecting rods 51 are arranged on the inner sides of the two second wheels 3. In an embodiment, the frame 1 includes two longitudinal beams arranged on two sides of the frame 1, respectively. The two longitudinal beams each have a through hole. The two connecting rods 51 are vertically inserted into the two longitudinal beams, respectively, and are fixed with the two longitudinal beams through a bolt. Two third wheels 52 are connected with the two connecting rods 51, respectively. The two third wheels 52 are arranged behind the two second wheels 3, respectively.

In an embodiment, a diameter of the third wheel 52 is smaller than a diameter of the first wheel 23. The diameter of the first wheel 23 is smaller than a diameter of the second wheel 3.

When the tractor travels on a level road, bottoms of the first wheel 23 and the second wheel 3 are aligned, while a bottom of the third wheel 52 is higher than that of the second wheel 3, that is, the third wheel 52 is suspended. When the tractor moves, the first wheel 23 and the second wheel 3 contact the ground, while the third wheel 52 does not. In such way, when the tractor transports the cargo carrier with heavy load on uneven terrain, the third wheel 52 can prevent the tractor from rollover, which enhances its stability.

In an embodiment, the tractor further includes a driving component 6. The driving component 6 is arranged on a bottom of the rear end of the frame 1. The driving component 6 is connected with the second wheel 3. The driving component 6 is configured to drive the second wheel 3 to rotate relative to the frame 1, so as to drive the frame 1 to move. In such way, the first wheel 23 is driven to rotate through the frame 1. A movement direction of the frame 1 can be adjusted by changing angles of the first wheel 23 and the second wheel 3 through external force.

In this embodiment, the driving component 6 is a motor. The number of the driving component 6 is two. Two driving components 6 are connected with the two second wheels 3, respectively.

Referring to FIG. 6, the tractor further includes a controller 7. The controller 7 is arranged on the frame 1, and is electrically connected with the driving component 6. The controller 7 is configured to control the driving component 6 to start or stop.

In this embodiment, the controller 7 is electrically connected with the two driving components 6. The tractor of the present disclosure, adopts a dual-motor drive structure, where the two driving components 6 can be independently controlled by the controller 7, which enables more rational torque distribution, reduces the risk of slippage, and is particularly suitable for steep slopes, muddy roads, or icy surfaces. Additionally, steering can be achieved by adjusting rotational speed differences between the two driving components 6, eliminating the need for traditional steering mechanisms or manual steering, which simplifies a mechanical structure and reduces physical exertion of the operator.

In an embodiment, the controller 7 is further configured to adjust a rotation direction of the driving component 6 to adjust a rotation direction of the second wheel 3. The controller 7, through the driving component 6, drives the second wheel 3 to rotate forward or reverse, so as to further drive the frame 1 to move forward or backward. Zero-radius turning, that is, making a U-turn in place, can be achieved through a reverse rotation of the driving component 6, which is more suitable for narrow spaces.

The tractor further includes a power supply. The power supply is arranged on the frame 1. The power supply is electrically connected with the two driving components 6, and is configured to supply power to the two driving components 6.

In an embodiment, the power supply is electrically connected with the controller 7, and is configured to supply power to the controller 7. The power supply is also configured to supply power to the driving component 6 through the controller 7.

Referring to FIG. 1, the tractor further includes a handle 8. The handle 8 is connected with the crossbeam 21, and is configured for an operator to hold. In an embodiment, the handle 8 is inclined relative to the crossbeam 21. In practical use, the operator holds the handle 8 to prevent the movement direction of the frame 1 from deviating. When the movement direction of the frame 1 needs to be adjusted, a force can be directly applied to the handle 8 toward a desired direction, so that the movement direction of the frame 1 turns toward the desired direction.

Referring to FIG. 1, the tractor further includes a remote control unit 9. The remote control unit 9 is wirelessly connected with the controller 7. The remote control unit 9 is configured to start or stop the driving component 6 through the controller 7. The remote control unit 9 is also configured to adjust the rotation direction of the second wheel 3 through the controller 7. By enabling wireless remote control for traction and motion functions, compared to the tractor in the prior art or manual operation, it offers enhanced flexibility and maneuverability, allowing for agile movement in confined, hazardous, or mixed human-machine working areas. Additionally, it provides improved safety and reliability by enabling operator-machine separation, thereby avoiding operator exposure to dangerous environments and reducing the risk of injury.

The tractor of the present disclosure is compact and agile, suitable for towing vehicles such as travel trailers and boats. It can operate on various surfaces including concrete roads, gravel paths, grass, and muddy terrain. Particularly in confined or narrow spaces, it offers significant towing advantages and can meet both household and commercial needs.

Described above are only preferred embodiments of the present disclosure, which are not intended to limit the disclosure. Under the spirits of this application, any equivalent replacements or direct/indirect application in other arts by utilizing the specification and accompanying drawings of this application shall fall within the scope of this application defined by the appended claims.

What is claimed is:

1. A tractor, comprising:
a frame; and
a first wheel assembly;
wherein the first wheel assembly comprises a crossbeam, a swing axle, a first wheel, a second wheel and a pin; the crossbeam is arranged on a first end of the frame; the crossbeam is provided with a first hole, and the first hole is configured to run through the crossbeam along a length direction of the crossbeam; the swing axle is inserted through the first hole; a cross-sectional dimension of the swing axle is smaller than that of the first hole; the pin is inserted in the swing axle and the crossbeam; the swing axle is configured to swing upward and downward within the first hole around an axis of the pin; and the first wheel is rotatably arranged on the swing axle; and
the second wheel is rotatably arranged on a second end of the frame, and is configured to drive the tractor.

2. The tractor of claim 1, wherein the first wheel assembly further comprises a connecting component; an upper part of the connecting component is fixedly arranged on an end of the swing axle; a lower part of the connecting component is connected with the first wheel; and the first wheel is configured to rotate relative to the connecting component.

3. The tractor of claim 2, wherein the number of the connecting component is two, the number of the first wheel is two, and the number of the second wheel is two; two connecting components are arranged on two ends of the swing axle, respectively; two first wheels are connected with the two connecting components, respectively; and two second wheels are arranged on two sides of the frame, respectively.

4. The tractor of claim 1, wherein the first wheel assembly is provided with a second hole configured to run through the crossbeam and the swing axle; the pin comprises a pin head, a pin shaft and a fixing component; the pin head is provided on a first end of the pin shaft; the pin shaft is inserted into the second hole; the fixing component is arranged on a second end of the pin shaft; and the pin head and the fixing component are respectively arranged on two opposite outer side walls of the crossbeam.

5. The tractor of claim 1, further comprising:
a ball joint;
wherein the ball joint is arranged on the frame, and is configured to connect with a cargo carrier.

6. The tractor of claim 1, further comprising:
a second wheel assembly;
wherein the second wheel assembly is arranged on the second end of the frame, and is arranged spaced apart from the second wheel.

7. The tractor of claim 6, wherein the second wheel assembly comprises a connecting rod and a third wheel; a first end of the connecting rod is connected with the frame, and a second end of the connecting rod is connected with the third wheel; and the third wheel is configured to rotate relative to the connecting rod.

8. The tractor of claim 1, further comprising:
a driving component;
wherein the driving component is arranged on the frame, and is connected with the second wheel; and the driving component is configured to drive the second wheel to rotate relative to the frame, so as to drive the frame to move.

9. The tractor of claim 8, further comprising:
a controller;
wherein the controller is arranged on the frame, and is electrically connected with the driving component; and the controller is configured to control the driving component to start or stop.

10. The tractor of claim 1, further comprising:
a handle;
wherein the handle is connected with the crossbeam, and is configured for an operator to hold.
